(19) United States
(12) Patent Application Publication
(10) Pub. No.: US 2026/0067710 A1
(43) Pub. Date: Mar. 5, 2026

(54) NON-TERRESTRIAL-NETWORK-AWARE TERRESTRIAL NETWORK BEAMFORMING FOR CO-CHANNEL INTERFERENCE MANAGEMENT

(71) Applicant: DISH Wireless L.L.C., Littleton, CO (US)

(72) Inventors: Gurpreet Sohi, Parker, CO (US); Mehdi Alasti, Arlington, VA (US); Sourabh Gupta, Ashburn, VA (US)

(21) Appl. No.: 18/818,928

(22) Filed: Aug. 29, 2024

(51) Int. Cl. H04W 16/28; H04W 72/12; H04W 72/541

(52) U.S. Cl. CPC H04W 16/28; H04W 72/12; H04W 72/541

(57) ABSTRACT

Approaches are described herein for mitigating co-channel interference conditions between non-terrestrial network (NTN) and terrestrial network (TN) communications. Embodiments use NTN-aware TN beamforming to mitigate such co-channel interference conditions. In particular, embodiments are concerned with instances in which downlink TN transmissions produce co-channel interference with uplink NTN reception, and/or in which downlink NTN transmissions produce co-channel interference with uplink TN reception. The TN beamforming can involve applying beam rotations to align nulls of TN radiation patterns with satellite beams to avoid interference and/or applying side lobe suppression to reduce TN gain in potentially interfering directions. The TN beamforming is informed by both NTN information (e.g., ephemeris information and beam information) and TN information (e.g., cell information).

### BACKGROUND OF THE INVENTION

Wireless connectivity continues to evolve to meet demands for ubiquity, convenience, reliability, speed, responsiveness, and the like. For example, each new generation of cellular communication standards, such as the move from 4G/LTE (fourth generation long-term evolution) networks to 5G (fifth generation) networks, has provided a huge leap in capabilities along with new and increasing demands on the infrastructures that enable those networks to operate. For example, 5G supports innovations, such as millimeter-wave frequencies, massive MIMO (Multiple Input Multiple Output), and network slicing, which enhance connectivity for unprecedented numbers of devices and data-intensive applications.

More recently, innovations in 5G networking (and its successors) have expanded from terrestrial-based communication infrastructures to so-called non-terrestrial network (NTN) infrastructures. NTN infrastructures leverage satellites and high-altitude platforms to extend 5G coverage and capabilities, such as to serve remote and otherwise underserved areas. Effective deployment of NTN solutions can help support connectivity and applications for rural users, emergency responders, global Internet-of-Things (IoT) deployments, etc.

However, non-terrestrial communications carry complexities and design concerns that are not present in terrestrial-based communications, which can add significant technical hurdles to NTN deployments. For example, effective ground-to-satellite communications involves accounting for orbital dynamics, handovers and/or other transitions between satellites, path loss, propagation delay, atmospheric conditions, inter-satellite and/or inter-beam interference, spectrum and regulatory considerations, and other considerations. Additionally, interference concerns can arise in regions where non-terrestrial beams and terrestrial cells are communicating over the same or similar portions of spectrum. New approaches continue to be developed to find technical solutions for overcoming, or at least mitigating, these and other technical hurdles.

### BRIEF SUMMARY OF THE INVENTION

Systems and methods are described herein for mitigating co-channel interference conditions between non-terrestrial network (NTN) and terrestrial network (TN) communications. Embodiments use NTN-aware TN beamforming to mitigate such co-channel interference conditions. In particular, embodiments are concerned with instances in which downlink TN transmissions produce co-channel interference with uplink NTN reception, and/or in which downlink NTN transmissions produce co-channel interference with uplink TN reception. The TN beamforming can involve applying beam rotations to align nulls of TN radiation patterns with satellite beams to avoid interference and/or applying side lobe suppression to reduce TN gain in potentially interfering directions. The TN beamforming is informed by both NTN information (e.g., ephemeris information and beam information) and TN information (e.g., cell information).

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B show a highly simplified communication environment.

FIG. 2 shows an example terrestrial network beam, as produced by a cell tower or other TN ground station.

FIG. 3 shows an example of a network environment having both non-terrestrial network (NTN) and terrestrial network (TN) portions.

FIG. 4 shows a partial communication environment that includes an illustrative embodiment of a non-terrestrial network (NTN) aware terrestrial network (TN) beamformer, according to embodiments described herein.

FIG. 5 shows a simplified terrestrial network (TN) portion of a communication environment in which a terrestrial network (TN) antenna radiation pattern is beamformed using side lobe suppression.

FIGS. 6A and 6B show a simplified terrestrial network (TN) portion of a communication environment in which a terrestrial network (TN) antenna radiation pattern is beamformed using beam rotation.

FIGS. 7A and 7B show a simplified terrestrial network (TN) portion of a communication environment in which a terrestrial network (TN) antenna radiation pattern is beamformed using both side lobe suppression and beam rotation.

FIG. 8 provides a schematic illustration of an embodiment of a computational system that can implement various system components and/or perform various steps of methods provided by various embodiments.

FIG. 9 shows a flow diagram of an illustrative method for non-terrestrial network (NTN) aware terrestrial network (TN) co-channel interference mitigation, according to embodiments described herein.

### DETAILED DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

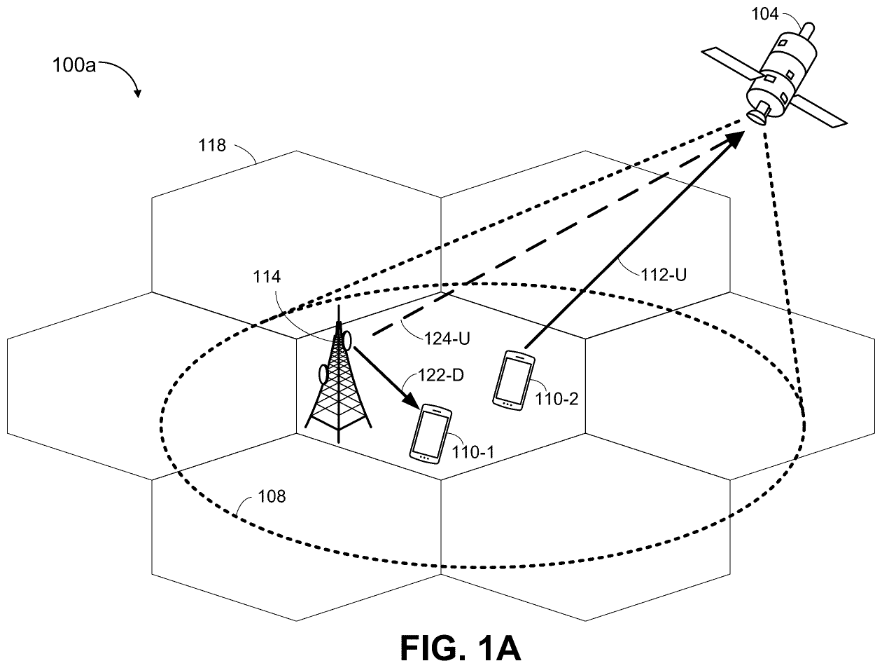

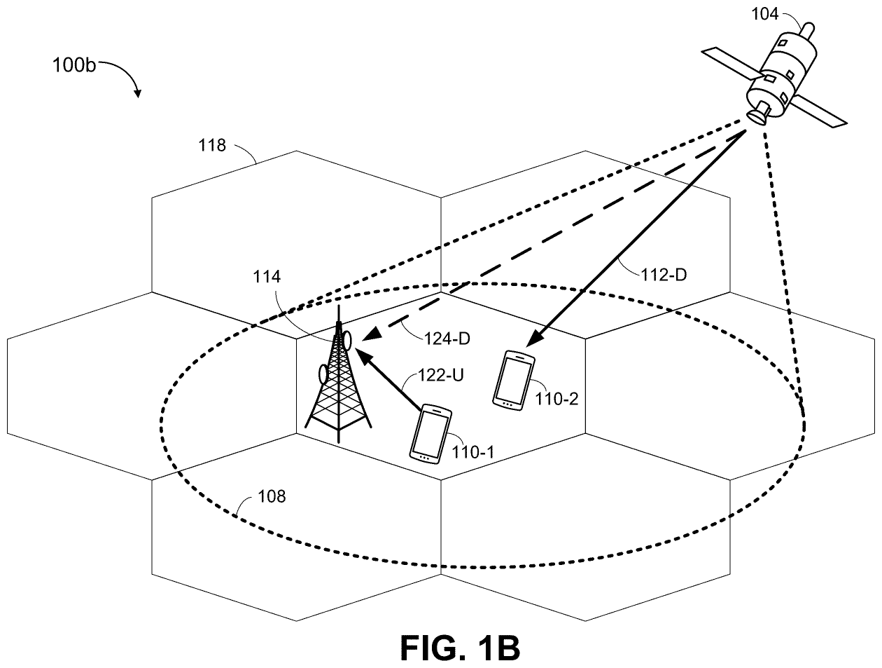

For the sake of providing context for embodiments described herein, FIGS. 1A and 1B show a highly simplified communication environment 100. The communication environment 100 includes both a non-terrestrial network (NTN) portion (e.g., including satellite network infrastructure) and a terrestrial network (TN) portion (e.g., including cellular network infrastructure). For embodiments described herein, the environment 100 is assumed to have at least some geographical regions and/or timeframes in which there is an overlap between TN communication coverage (e.g., cellular coverage) and NTN communication coverage (e.g., satellite beam coverage). The NTN portions of the network can be an NTN extension of a TN infrastructure. For example, fifth generation (5G) cellular standards support NTN extensions and define ways in which the NTN portion can be modified to implement 5G new radio (NR) protocols and other 5G concepts. In some implementations, the NTN and TN portions of the network are fully integrated. In other implementations, there is only enough integration to facilitate features described herein. For example, embodiments described herein perform TN beamforming based on a knowledge of potential interference conditions between overlapping TN and NTN communications. Implementing such features involves enough integration so that the TN is aware of salient information about NTN communications.

The illustrated environment 100 includes cells 118 produced by cell towers 114 and defining respective cell coverage areas on the surface of the Earth. Although only a single cell tower 114 is shown in the simplified illustration, a real-world deployment will have many cell towers 114. A network of cell towers 114 is strategically positioned to provide coverage across a defined geographic area, and each cell tower 114 can transmit and receive signals to and from user terminals 110 (e.g., mobile devices) within its coverage area (i.e., its cell 118). Notably, reference to “cell towers” is intended to include any located on which terrestrial antennas are mounted. For example, terrestrial antennas can also be installed on buildings, etc. Depending on many factors (e.g., terrain, frequency band, physical obstacles, etc.), the effective communication range of a single cell tower 114 can range from only a few hundred meters to several tens of kilometers. Each cell tower 114 can typically service multiple cells 118, such as by including multiple cellular antennas, using sectorization, etc. A typical urban deployment may have a much higher density of cells 118, such as spaced 0.1 to 1.2 miles apart. Each urban cell tower 114 may serve smaller cells 118, known as microcells or picocells. A typical rural deployment may have a lower density of cells 118, such as spaced 3 to 18 miles apart, or farther. Each rural cell tower 114 typically cover larger cells 118, known as macrocells.

Although there is estimated to be over one million cell towers 114 worldwide, the cell towers 114 alone cannot provide global coverage. As noted above, recent standards (e.g., 5G) have begun to facilitate NTN extensions to those cellular networks. The illustrated environment 100 includes beams 108 produced by satellites 104. The beams 108 define respective beam coverage areas on the surface of the Earth. Although only a single satellite 104 and a single beam 108 are shown in the simplified illustration, a real-world deployment can have many satellites 104 and/or many beams 108. In some cases (and/or at some times), beams 108 and cells 118 cover different geographic areas; in other cases (and/or at other times), beams 108 and cells 118 have overlapping coverage areas. For example, the illustrated environment 100 shows a beam 108 having overlapping coverage with several cells 118. The illustrated number and sizes of the cells 118 relative to the beam 108 is not intended to be representative of an actual deployment. Depending on factors, such as population density, beam size, cell size, cell tower density, topology, etc., tens or hundreds of cells 118 can fit within a single beam coverage area.

Embodiments herein operate on a per-TN-radiation-pattern basis. For example, as described below, embodiments evaluate each radiation pattern at each of a number of schedule times, to determine whether there is a potential interference condition with that radiation pattern. For the sake of simplicity, some descriptions show and/or refer to a particular cell tower 114 as associated with a cell 118 and also as producing a radiation pattern. In practice, there is not typically a one-to-one correspondence between a cell tower 114, a cell 118, and a radiation pattern. For example, although each “cell” in FIG. 1 is illustrated (as per convention) in a simplified manner as a hexagonal area, the actual coverage area of each cell 118 is typically an irregular shape resulting from an overlap of one or more radiation patterns from one or more terrestrial antennas on one or more cell towers 114. As one typical example, a single cell tower 114 can have three sector antennas installed thereon, each pointing approximately 120 degrees away from each other to provide sectorized 360-degree coverage that effectively defines the coverage area of the cell 118. The same cell tower 114 may have other antennas installed thereon for supporting other cells for other frequency bands, other tenants or service providers, etc., but those are typically considered as supporting other cells 118.

Thus, as used herein, reference to overlap between a beam 108 and a “cell” 118 is intended to mean overlap between the coverage area of a beam 108 and a region corresponding to a particular radiation pattern produced by a particular TN antenna operating in a cell 118. Similarly, references herein to evaluating each cell 118 to determine whether there is an interference condition, to applying beamforming to each cell 118, and/or the like are intended to mean that such features are directed to each TN antenna (i.e., to each radiation pattern) even where multiple antennas are technically in a same cell 118. For example, although a single cell 118 may be formed by an overlap of radiation patterns from three sectorized antennas, embodiments herein determine interference conditions, apply beamforming, etc. for each of the three TN antennas.

In some implementations, the satellites 104 are geosynchronous orbit (GEO) satellites 104. For example, a typical GEO satellite can orbit the Earth at an altitude of approximately 35,786 kilometers (22,236 miles) above the equator, so that the satellite's orbit matches the Earth's rotation, and the satellite effectively remains stationary relative to a fixed point on the Earth's surface. Each GEO satellite can typically produce large numbers (e.g., dozens, hundreds, etc.) of spot beams 108 to cover extensive geographic areas and support high-capacity data transmissions.

In other implementations, the satellites 104 are non-geosynchronous orbit (NGSO) satellites 104, such as low-Earth orbit (LEO) or medium-Earth orbit (MEO) satellites 104. LEO satellites typically orbit the Earth at altitudes ranging from 180 kilometers (112 miles) to 2,000 kilometers (1,242 miles), thereby enabling lower-latency communication services. Each LEO satellite typically produces a smaller number of beams 108, such as one beam 108, four beams 108, or even tens of beams 108. Often, such satellites 104 are deployed in constellations, sometimes including tens, hundreds, or thousands of satellites 104 to provide global coverage as they move rapidly in one or more orbits, orbital planes, etc. MEO satellites typically orbit at altitudes between 2,000 kilometers (1,242 miles) and 35,786 kilometers (22,236 miles). They are often deployed in smaller constellations, and each MEO satellite often produces a higher number of larger beams 108 than LEO satellites, so that the constellation can cover larger regions with fewer satellites 104.

Although embodiments of NTN portions of the network are described herein with reference to satellite communications, NTN portions can also be implemented using high-altitude platform systems (HAPS), or the like. HAPS are aerial platforms, such as balloons, airships, or unmanned aerial vehicles (UAVs), that operate in the stratosphere at altitudes typically between 17 to 22 kilometers (approximately 10.5 to 13.7 miles) above the Earth's surface. In the NTN context, HAPS can be strategically positioned to provide telecommunications and broadband services over wide geographic areas. For example, by operating above weather disturbances and commercial air traffic, HAPS can deliver stable and reliable connectivity. Some NTN deployments can additionally or alternatively use low-altitude platform systems (LAPS), and/or other non-terrestrial platforms.

As noted above, beams 108 and cells 118 can have overlapping coverage areas. The NTN portion of the network (e.g., the satellite portion) communicates using NTN frequency bands and the TN portion of the network (e.g., the cellular portion) communicates using TN frequency bands. In some deployments, NTN frequency bands can overlap with TN frequency bands. The overlaps can cause co-channel interference between the NTN and TN communications. Such interference can degrade the quality of service, reduce data throughput, cause communication disruptions for users on one or both networks, and/or cause other undesirable degradations.

Embodiments described herein are particularly focused on two co-channel interference scenarios. FIG. 1A illustrated a first co-channel interference scenario in which a downlink (DL) portion of TN communications manifests co-channel interference with an uplink (UL) portion of NTN communications. For example, FIG. 1A shows a TN DL from the cell tower 114 to a first UT 110-1 (TN DL 122-D) and a first NTN UL from a second UT 110-2 to the satellite 104 (NTN UL 112-U). Overlap in transmission frequencies for TN DL 122-D and NTN UL 112-U can potentially manifest an interfering second NTN UL from the cell tower 114 to the satellite 104 (NTN UL 124-U, shown as a dashed line). This can impact communications on the network in several ways. For example, such an interference scenario can reduce data throughput for both TN and NTN users (e.g., NTN devices may experience slower upload speeds due to the interference from the DL signals of the TN), increase latency due to delays in signal processing and retransmissions, degrade signal quality, reduce network reliability (e.g., including increasing the potential for dropped connections, service interruptions, etc.), increase power consumption, etc.

FIG. 1B illustrated a second co-channel interference scenario in which a downlink (DL) portion of NTN communications manifests co-channel interference with an uplink (UL) portion of TN communications. For example, FIG. 1B shows a TN UL to the cell tower 114 from the first UT 110-1 (TN UL 122-U) and a first NTN DL to the second UT 110-2 from the satellite 104 (NTN DL 112-D). Overlap in transmission frequencies for TN UL 122-U and NTN DL 112-D can potentially manifest an interfering second NTN DL to the cell tower 114 from the satellite 104 (NTN UL 124-D, shown as a dashed line). This can impact communications on the network in several ways. For example, such an interference scenario can reduce data throughput for TN users (e.g., including slower upload speeds due to the interference from the DL signals of the NTN), increase latency, degrade signal quality, reduce network reliability, increase power consumption, etc.

In general, several planned advancements in NTN deployment rely on spectrum sharing between the TN and NTN technologies, and effective spectrum sharing relies on avoiding interference when TN and NTN communications overlap in time, space, and frequency. Embodiments described herein seek to facilitate spectrum sharing, at least in interference scenarios, such as those described in FIGS. 1A and 1B. Embodiments described herein seek to mitigate TN-NTN interference using NTN-aware TN beamforming. For example, present 3GPP 5G NR standards support both analog and digital beamforming. Digital beamforming is typically provided by using massive MIMO (multiple input multiple output), by which a large number of antennas at a base station are transmit or receive in a coordinated manner to create highly directional radiofrequency beams. In particular, advanced signal processing algorithms are used to control the phases and amplitudes of the signals transmitted or received by each antenna element. Massive MIMO can be used on both “FR1” and “FR2” frequency bands. Present specifications also support analog beamforming as follows: up to 4 beams below 3 GHz, up to 8 beams between 3 GHz and 7.125 GHz, and up to 64 beams for FR2 bands.

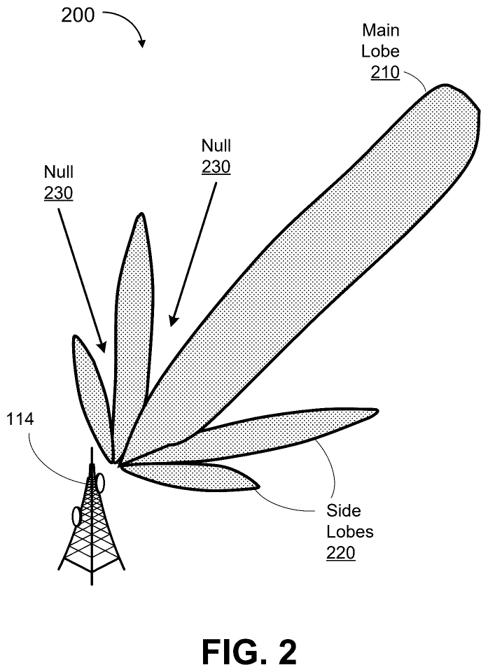

As further context for such beamforming, FIG. 2 shows an example terrestrial network beam 200, as produced by a cell tower 114 or other TN ground station (e.g., a next generation “NodeB” (gNodeB, or gNB), enhanced gNB (eNodeB, eNB), etc.). As illustrated, the TN beam 200 is a directional radio wave transmission pattern characterized by a main lobe 210, side lobes 220, and nulls 230. The main lobe 210 is the part of the beam where the majority of the signal power is concentrated and which provides the highest gain. Side lobes 220 are secondary lobes of radiation that appear at angles away from the main lobe 210. The side lobes 220 typically have appreciably lower gain and signal strength. The nulls 230 are points in the radiation pattern where the signal strength drops very low relative to the main lobe 210 and side lobes 220 (e.g., to near zero). As one example, the main lobe 210 has a gain of around 12 to 18 dBi (decibels relative ot an isotropic radiator), the side lobes 220 have gains of around −10 to −15 dB relative to the main lobe 210, and there is near-zero gain at the nulls 230.

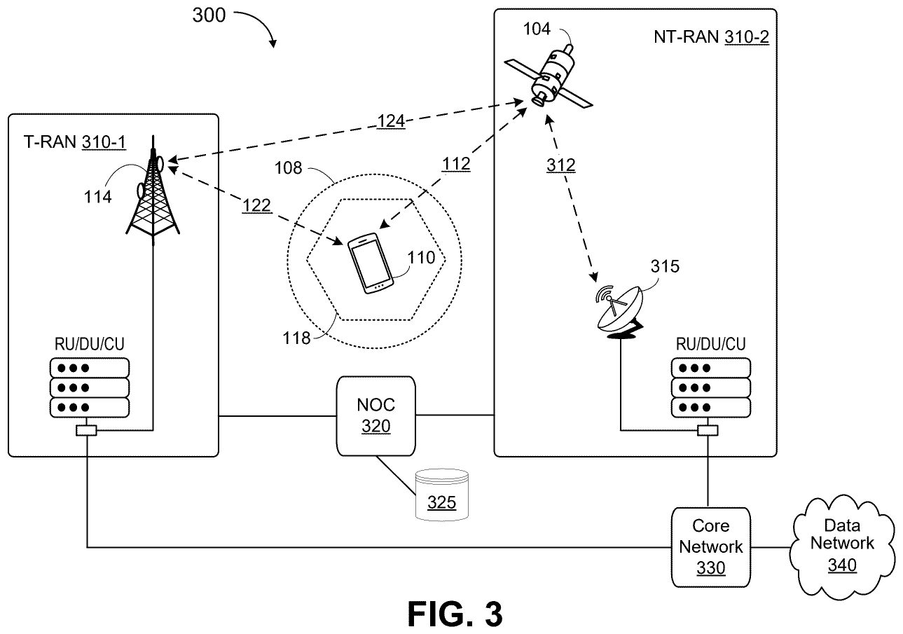

For added context, FIG. 3 shows an example of a network environment 300 having both non-terrestrial network (NTN) and terrestrial network (TN) portions. The network environment 300 can be an implementation of the network environment 100 of FIG. 1A and B. Notably, FIG. 3 represents a type of network environment 300 in which the same operator provides both the TN and NTN services using a shared core network. Embodiments described herein can operate in such an environment 300 but are not limited to such an environment 300. For example, embodiments can similarly operate in network environments where two independent operators (a TN operator and an NTN operator) share the same spectrum, and the TN operator maintains information about satellite beam coverages, ephemeris data, and frequency band-beam mappings. Thus, FIG. 3 is intended to provide one type of context for embodiments herein.

As described with reference to FIGS. 1A and 1B, the NTN portion produces beams 108, and the TN portion produces cells 118. As described with reference to FIG. 2, the “cells” can be considered as radiation patterns, or TN beams, with a main lobe, side lobes, and nulls. In some geographical locations and/or at some times, one or more beams 108 can overlap with one or more cells 118, potentially resulting in co-channel interference, including downlink co-channel interference. In this context, a beam 108 overlaps with a cell 118 when the radiation pattern of the beam 108 overlaps in time, space, and frequency with the radiation pattern of the cell 118 with enough power to cause interference that impacts communications with user terminals (UTs) 110 in those overlapping regions. Only a single user terminal 110 is shown located within a single cell 118 fully overlapped by a single beam 108. This is intended generally to represent any suitable number of user terminals 110 located within any suitable number of cells 118 fully or partially overlapped by any suitable number of beams 108.

As illustrated, the communication environment 300 can be considered as having two radio access networks 310: a terrestrial RAN (T-RAN) 310-1 and a non-terrestrial RAN (NT-RAN) 310-2. The T-RAN 310-1 provides wireless connectivity between UTs 110 and a core network 330. As noted above, the environment 300 of FIG. 3 shows a shared core network 330, but embodiments described herein can operate in environments having separate TN and NTN core networks. The T-RAN 310-1 can include cell towers 114 (also referred to as base stations, gNodeBs, gNBs, etc.), antennas, radio frequency (RF) transceivers, backhaul connections, and/or any other suitable components. The cell towers 114 are equipped with multiple antennas to support advanced technologies, such as sectorization, Massive MIMO (Multiple Input Multiple Output), and beamforming. Such technologies can enhance spectral efficiency and network capacity by enabling the simultaneous transmission of multiple data streams to different UTs 110. The RF transceivers convert digital signals into RF signals and vice versa, facilitating wireless communication. Backhaul connections, such as fiber optic or microwave links, connect the cell towers 114 to the core network 330. The T-RAN 310-1 performs several roles, such as managing network resources, performing radio resource management (RRM) (e.g., handovers, load balancing, and interference mitigation), etc.

The T-RAN 310-1 can establish TN uplink and downlink channels 122 with UTs 110. The T-RAN 310-1 can establish and perform uplink and downlink communications over those TN-UT channels 122 through a series of well-coordinated steps. For example, a cell tower 114 broadcasts synchronization signals and system information blocks (SIBs) that enable the UTs 110 to detect and synchronize with the network. Once a UT 110 is connected, the cell tower 114 assigns radio resources for downlink transmission. Data from the core network 330 arrives at the cell tower 114 via the backhaul connection, where it is processed and modulated into RF signals by the RF transceivers. Advanced beamforming techniques (including those described herein) are employed to direct these RF signals towards the UT 110, optimizing signal strength and minimizing interference. The UT 110 receives the RF signals through its antenna, demodulates them, and processes the data for the end-user. Throughout this process, the cell tower 114 continuously monitors the link quality and adjusts transmission parameters, such as power levels and modulation schemes, to ensure robust and efficient downlink communication.

The NT-RAN 310-2 includes satellite communication components, such as satellites 104 and ground stations 315 (e.g., gateways, NTN UTs (such as very small-aperture terminals, VSATs), etc.). In environments like the communication environment 300, the NT-RAN 310 is configured to extend the TN (e.g., 5G) coverage, such as to remote, rural, and underserved areas where terrestrial infrastructure is impractical or otherwise unavailable. The satellites 104 themselves include and facilitate communication features, such as transponders, antennas, beamforming capabilities, inter-satellite links, etc. Ground stations 315 effectively interface between the NT-RAN 310-2 and the terrestrial core network 330. For example, the ground stations 315 can handle data routing, frequency conversion, signal amplification, and/or other features.

The NT-RAN 310-2 can establish NTN uplink and downlink channels 112 with UTs 110. In the NT-RAN 310-2, uplink and downlink communications with UTs 110 via those NTN-UT channels 112 can involve sophisticated processes to leverage both NTN and TN (e.g., satellite and cellular) technologies. For example, downlink communications begin with data transmission from the core network 330 to a ground station 315, which then uplinks the data to a satellite 104. The core network 330 can communicate to the ground station 315 via the NT-RAN 310-2. Depending on the architecture option, the NT-RAN 310-2 can be implemented completely on the ground between the core network 330 and the ground station 315, or the NT-RAN 310-2 can be implemented partly on the ground and partly on the satellite. In one implementation, the NT-RAN 310-2 is implemented completely onboard the satellite 104, and the UPF (user plane function of the core network 330) is also implemented onboard the satellite 104.

The satellite 104 receives the uplinked signals via its onboard antennas, and its transponders process and amplify the signals. The satellite 104 directs the downlink RF signals (e.g., using beamforming and/or other techniques) towards a UT's 110 location, optimizing signal coverage and strength. The UT 110, equipped with a satellite-compatible antenna and receiver, captures the downlinked RF signals, demodulates them, and processes the data for an end-user. Throughout the communication process, the satellite 104 continuously adjusts its beam patterns and transmission parameters to maintain optimal link quality. In some implementations, inter-satellite links (ISLs) can be used to relay data directly between satellites 104.

As noted, NT-RAN 310-2 communications involve communications between the satellites 104 and ground stations 315. For such communications, the NT-RAN 310-2 can establish NTN-GW (uplink and downlink) channels 312 with the ground stations 315. As illustrated, there can be an effective communication channel 124 between the satellites 104 and cell towers 114. In some network embodiments, this can be an actual, intentional TN-NTN communication channel 124 for carrying direct communications between the satellites 104 and cell towers 114. In contexts of inventions described herein, the TN-NTN channel 124 is a representation of co-channel interference between the TN and NTN communications. As described with reference to FIGS. 1A and 1B, this includes scenarios in which TN downlink transmissions via TN-UT channel 122 create interference on satellite access link uplink reception and/or scenarios in which NTN satellite access link transmissions create interference on TN uplink reception via TN-UT channel 122.

As illustrated, both the T-RAN 310-1 and the NT-RAN 310-2 are in communication with a network operations center (NOC) 320. As noted above, other embodiments can operate in context of environments where the TN and NTN portions are loosely coordinating and do not both communicate with a same NOC 320. The NOC 320 generally serves as the centralized hub for overseeing the performance, health, and security of the entire network infrastructure (i.e., both the NTN and the TN portions of the network environment 300). For example, the NOC 320 includes network management systems (NMSs) to provide real-time dashboards, alerts, and control mechanisms for both the T-RAN 310-1 and the NT-RAN 310-2. The NOC 320 can use telemetry and protocols (e.g., Simple Network Management Protocol (SNMP)) to collect performance data (e.g., signal quality, traffic load, fault occurrences, etc.) from cell towers 114 in the T-RAN 310-1 and from satellites 104 and ground stations 315 in the NT-RAN 310-2. The NOC 320 can analyze the data to support proactive fault detection, performance optimization, configuration management, security management, and or other features.

As noted above, both the T-RAN 310-1 and the NT-RAN 310-2 are in communication with a core network 330. The core network 330 can be implemented as a software-defined infrastructure to manage and orchestrate the entire ecosystem, including both the T-RAN 310-1 and the NT-RAN 310-2. The core network 330 can perform several roles, such as handling session management and mobility management, managing authentication and authorization processes, implementing network slicing, facilitating data routing and forwarding, overseeing policy control and charging, etc. Although certain terminology used herein is typically associated with 5G ecosystems, embodiments can be implemented in any suitable current or future wireless infrastructure, such as 6G. For example, in the 5G context, the core network 330 can be referred to as the 5G core (5GC), but embodiments can be implemented with future 6G core networks 330, as well.

The core network 320 also acts as a central hub to connect the T-RAN 310-1 and the NT-RAN 310-2 to one or more external data networks (illustrated generally as data network 340). The core network 330 and the data network 340 are connected via high-capacity, low-latency links that facilitate rapid and seamless data exchange. The data network 340 can include any suitable networks, such as the Internet, private enterprise networks, cloud services, content delivery networks (CDNs), etc. The data network 340 can also provide several services, such as web hosting, online applications, streaming services, cloud computing platforms, IoT ecosystems, enterprise VPNs, etc.

The illustrated architecture is intended generally to represent possible integration between NTN and TN infrastructures. For example, both the T-RAN 310-1 and the NT-RAN 310-2 are generally illustrated as including “RU/CU/DU” components, corresponding to radio unit (RU), distributed unit (DU), and central unit (CU) functions. Each RU is responsible for transmission and reception of radiofrequency signals and interfaces directly with antennas to convert between analog and digital signal spaces. In some disaggregated models, the RU is also responsible for lower physical (PHY) layer functions. Each DU is responsible for real-time, lower-layer baseband processing, such as higher physical layer (Layer 1) processing (e.g., error correction, modulation/demodulation, encryption/decryption, etc.), and some media access control (MAC) layer (in Layer 2). In some disaggregated models, the DU is also responsible for radio link control (RLC) functions. Each CU is responsible for higher-layer functions, packet data convergence protocol (PDCP), and radio resource control (RRC) layers. The CU can also be responsible for service data adaptation protocol (SDAP) functions, such as mapping quality of service (QoS) flows to data radio bearers (DRBs).

In some implementations, the T-RAN 310-1 and/or the NT-RAN 310-2 are architected according to open radio access network (O-RAN) principles and protocols. O-RAN is an architecture that seeks to standardize interfaces between RAN components to allow network operators to mix and match products from different vendors. O-RAN deployments tend to leverage disaggregation, artificial intelligence (AI), machine learning (ML), and/or other technologies for network optimization. For example, embodiments can implement the RU, DU, and CU functions as virtualized network functions (VNFs) with standardized network interfaces. Other embodiments can implement the RU, DU, and CU functions as containerized network functions (CNFs). Integration of O-RAN principles into such deployments can increase flexibility, scalability, and efficiency of the network architecture.

For the sake of simplicity, the illustrated environment 300 shows the RU/DU/CU components located together and in a particular RAN location. In particular, the in the RU/DU/CU components of the T-RAN 310-1 are shown between the cell towers 114 and the core network 330, and the RU/DU/CU components of the NT-RAN 310-2 are shown between in the ground stations 315 and the core network 330. However, different architectures can locate the RU, DU, and CU components in different ways. In some implementations, the RUs in the T-RAN 310-1 can be deployed at the cell towers 114 (or other base station sites) to handle transmission and reception between the cell towers 114 and the UTs 110, and the RUs in the NT-RAN 310-2 can be deployed as part of the satellite 104 payloads to handle transmission and reception between the satellites 104 and the UTs 110. The DUs in the T-RAN 310-1 can be deployed within a cell tower's 114 physical site or in a more central location, such as in a nearby facility, and the DUs in the NT-RAN 310-2 can similarly be deployed on the satellite 104 or in a more central location, such as in or near a ground station 315. In one embodiment, the CUs in both the T-RAN 310-1 and the NT-RAN 310-2 are deployed in centralized ground-based data centers (e.g., in the NOC 320) to leverage computational resources and facilitate efficient network management. In some implementations that have regenerative satellites 104, certain of the RAN functions can be implemented in the satellites 104 (i.e., on the satellite payload). In one such implementation, the RU, DU, and CU functions are all be implemented in the satellites 104. In another such implementation, only the RU functions are implemented in the satellites 104, and the DU and CU functions are implemented in the NT-RAN 310-2. In another such implementation, the RU and DU functions are implemented in the satellites 104, and the CU functions are implemented in the NT-RAN 310-2. As noted above, other implementations can operate with other architectures. For example, the NT-RAN 310-2 can be implemented completely on the ground between the core network 330 and the ground station 315, or the NT-RAN 310-2 can be implemented partly on the ground and partly on the satellite. In one implementation, the NT-RAN 310-2 is implemented completely onboard the satellite 104, and the UPF (user plane function of the core network 330) is also implemented onboard the satellite 104.

As noted above, embodiments are considered with conditions in which there is overlap between NTN beam 108 coverage and TN cell 118 coverage. In some NTN deployments that use GEO satellites 104, beam 108 coverage areas may be relatively fixed, so that the overlap areas are substantially constant over time. However, other categories NTN deployments result in changing overlap areas over time. One category is NTN deployments having satellites 104 that employ beam hopping, or other dynamic beam pointing. For example, even for GEO satellites, determining which cells 118 are being overlapped by which beams 108 at any moment is dependent on the present temporal location relative to the beam-hopping schedule.

Another category is NTN deployments using NGSO satellites 104. For both LEO and MEO satellites 104, their non-geosynchronous orbits result in constant movement of their respective beam 108 coverage areas relative to the surface of the Earth. The precise locations of each satellite 104 at any time is provided by ephemeris data. The ephemeris data includes information on the satellite's 104 orbital elements, such as its semi-major axis, eccentricity, inclination, right ascension of the ascending node, argument of perigee, mean anomaly, and/or other parameters. Additionally, ephemeris data can include information on the satellite's 104 velocity, attitude, and other relevant parameters for accurate positioning. The ephemeris data can be defined and stored in formats standardized by organizations such as the International Global Navigation Satellite System (GNSS) Service (IGS).

To derive the future location of a particular beam 108 of a satellite 104, the ephemeris data can be used in conjunction with algorithms that calculate the satellite's 104 trajectory over time. The satellite's 104 future position and orientation can be predicted by inputting current ephemeris data into such algorithms. The beams 108 of a satellite 104 are directed based on its position and attitude. Thus, the predicted future position and orientation of the satellite 104 can be used to precisely calculate where each beam will be directed at any given future time.

Embodiments include a database 325 to store present ephemeris data, beam 108 data, and cell 118 data. Some implementations can store additional suitable data to support features described herein. The illustrated environment 300 shows a single database 325 in or coupled with the NOC 320. Other implementations can include any suitable number of databases 325 in any suitable location(s). For example, the database(s) 325 can be implemented in a remote server or the cloud (e.g., accessible via a data network 340 via the core network 330), in the core network 330, in one or more ground stations 315, etc.

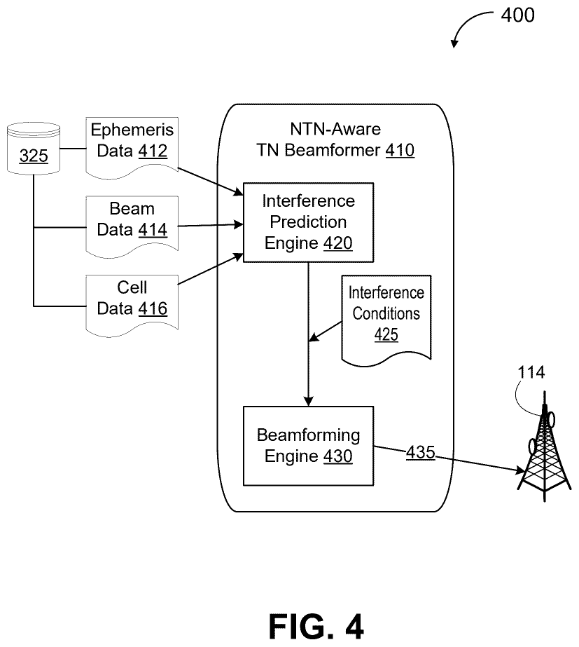

Though not explicitly shown, the environment 300 includes an NTN-aware TN beamformer. FIG. 4 shows a partial communication environment 400 that includes an illustrative embodiment of a non-terrestrial network (NTN) aware terrestrial network (TN) beamformer 410, according to embodiments described herein. As illustrated, the NTN-aware TN beamformer 410 includes an interference prediction engine 420 and a beamforming engine 430. The interference prediction engine 420 is in communication with the database(s) 325 described with reference to FIG. 3. As described there, the database(s) 325 maintain ephemeris data 412 and beam data 414 for the NTN portion of the overall communication environment and cell data 416 for the TN portion of the overall communication environment.

Embodiments of the NTN-aware TN beamformer 410 can be located in any suitable one or more locations in the network, such that the NTN-aware TN beamformer 410 has access to salient information for making interference predictions and has the ability to direct beamforming of TN antenna radiation patterns. In some implementations, some or all of the NTN-aware TN beamformer 410 is implemented in a radio access network (RAN) intelligence controller (RIC). For example, the RIC can have at least the interference prediction engine 220 integrated therewith. In an O-RAN architecture, the RIC can be implemented in several ways. In some such implementations, some or all of the NTN-aware TN beamformer 410 can implemented in the Near-Real-Time RIC, which is typically located near the edge of the network, such as in a DU of the T-RAN (e.g., T-RAN 310-1 of FIG. 3) or in an edge cloud infrastructure. In other such implementations, some or all of the NTN-aware TN beamformer 410 can be implemented in the Non-Real-Time RIC, which is typically located in a CU of the T-RAN (e.g., T-RAN 310-1 of FIG. 3), or in a more centralized cloud infrastructure.

In other embodiments, the interference detection and/or beamforming features of the NTN-aware TN beamformer 410 can be implemented in one or more other locations in the network. For example, interference detection features can be implemented in an RU, DU, CU, baseband unit (BBU), network management system (NMS), cloud radio access network (C-RAN), network function virtualization (NFV) infrastructure, or one or more edge computing nodes. Similarly, the beamforming features of the NTN-aware TN beamformer 410 can be implemented in an RU, DU, CU, BBU, NMS, C-RAN, NFV infrastructure, one or more edge computing nodes, or other suitable location(s).

The interference prediction engine 420 is configured to predict, at any particular time, which cells 118 will be overlapping with which beams 108 at that time based on the ephemeris data 412, beam data 414, and cell data 416. As described above, the ephemeris data 412 is used to predict a location and orientation (attitude) of a satellite 104 (not shown) at the particular time based on the satellite's trajectory, orbital dynamics, etc. and predefined algorithms.

The predicted location and orientation of the satellite 104 are used to determine the coverage area of its beam 108 (or coverage areas of its beam 108, if the satellite 104 concurrently projects multiple beams 108 at the particular time). In some implementations, the beam coverage areas are computed (predicted) only from predicted location and orientation of the satellite 104 and stored information about satellite 104 characteristics (e.g., the orientations of its antennas relative to its orientation, its altitude, the sizes of its spot beams, etc.). In other implementations, the beam data 414 includes some or all of the salient data for translating the predicted location and orientation of satellite(s) 104 into beam coverage areas. The beam data 414 also associates each beam 108 with a frequency band over which the beam 108 is communicating.

Embodiments of the interference prediction engine 420 are configured to determine interference conditions 425 between beams 108 and cells 118. Embodiments perform this determination for each cell 118 of the TN and for each schedule time of a beam schedule. The determination can include obtaining a pre-scheduled TN radiation pattern for the cell 118 in the schedule time based on the cell data 416. The cell data 416 associates cells 118 with geographic regions covered by their respective radiation patterns. As noted above, as used herein, reference to a “cell” 118, or the geographic region of a “cell” 118, or the like is intended to refer to a particular terrestrial antenna radiation pattern, even if a single cell 118 is technically formed by multiple antennas and radiation patterns. For example, the geographic region or coverage area of a cell 118, as used herein, means the geographic region or coverage area of a particular radiation pattern produced by a particular TN antenna in a call 118, even if that radiation pattern is technically only providing one sector, or one portion of the region considered to be the entire cell. As such, reference to the interference prediction engine 420 determining interference conditions 425 “for each cell 118” means that the interference prediction engine 420 determines interference conditions for each radiation pattern produced by each TN antenna in each cell 118 of the TN.

The interference prediction engine 420 further determines beam coverage areas of beams produced by the NTN in the schedule time, based on the ephemeris data 412 and the beam data 414. The interference prediction engine 420 can then determine a set of interference conditions 425 for the cell 118 in the schedule time. Each interference condition 425 corresponds to an instance in which the pre-scheduled TN radiation pattern is overlapped by one or more of the beam coverage areas of one or more of the beams 108, thereby producing corresponding co-channel interference between the cell 118 and one or more of the beams 108 during the schedule time. As illustrated in FIG. 2, the radiation pattern of a particular cell, includes a main lobe 210 and side lobes 220. Co-channel interference can arise from overlap between one or more beams 108 and any lobe of the TN antenna radiation pattern (i.e., either the main lobe 210 or a side lobe 220). Thus, the determination by the interference prediction engine 420 includes looking for overlap of any lobes of the TN antenna radiation pattern.

In some cases, the determination for the cell 118 for the schedule time can be a null set (i.e., no interference conditions 425 are found for that particular cell 118 in that particular schedule time). When the set of interference conditions 425 is not null, each determined interference condition 425 is defined in terms of the corresponding co-channel interference found between the corresponding cell 118 and the corresponding one or more beams 108 during the corresponding schedule time. In some embodiments, the output of the interference prediction engine 420 is a table (or any suitable data structure) of interference conditions 425, whereby each entry is an association between a corresponding co-channel interference, corresponding cell 118, corresponding one or more beams 108, and corresponding schedule time.

In one implementation, the interference prediction engine 420 computes the beam coverage areas in a same coordinate system used to geographically define the cell coverage areas (i.e., the coverage areas of the TN antenna radiation patterns). In other implementations, the interference prediction engine 420 maps the computed beam coverage areas and/or the cell coverage areas into a common coordinate system. The interference prediction engine 420 generates a set of interference conditions 425 for each particular time, such that the interference conditions 425 indicate each instance in which a cell 118 is determined to be geographically overlapping with a beam 108.

In some cases, all beams 108 of the NTN infrastructure communicate in an NTN spectrum band that overlaps with spectrum used by cells 118 of the TN infrastructure. In such cases, all cases of overlap are treated as interference conditions 425. In other cases, only some beams 108 of the NTN infrastructure communicate in a frequency band that overlaps with spectrum used by cells 118 of the TN infrastructure. In some implementations for such cases, only the subset of beams 108 communicating over overlapping spectrum are considered in the above determination of interference conditions 425. For example, such implementations may only compute beam coverage areas for the subset of beams 108, and/or such implementations may only determine whether there is overlap involving the subset of beams 108. In other implementations for such cases, interference conditions 425 are computed for all beams 108 initially as candidate interference conditions 425. The candidate interference conditions 425 are then filtered into a final list of interference conditions 425 by removing any of the candidate interference conditions 425 in which there is no spectrum overlap.

Embodiments described herein generally assume that each interference condition 425 falls into one of two categories of interference scenarios. One category of interference scenarios includes instances where a downlink TN transmission via the corresponding cell produces the corresponding co-channel interference with uplink NTN reception via the corresponding one or more beams (e.g., as illustrated in FIG. 1A). Another category of interference scenarios includes instances where a downlink NTN transmission via the corresponding one or more beams produces the corresponding co-channel interference with uplink TN reception via the corresponding cell (e.g., as illustrated in FIG. 1B).

Embodiments of the beamforming engine 430 are coupled with the interference prediction engine 420 and are configured to direct beamforming in a manner that mitigates identified interference conditions 425. In some implementations, for each of the interference conditions 425, the beamforming engine 430 computes and applies appropriate beamforming to the pre-scheduled TN radiation pattern for the corresponding cell in the corresponding schedule time to mitigate the corresponding co-channel interference with the corresponding one or more beams.

Embodiments of the beamforming engine 430 generally apply two types of beamforming to the TN antenna radiation patterns. One type of beamforming performed by the beamforming engine 430 involves applying a rotation to a pre-scheduled TN radiation pattern to align one or more nulls of the pre-scheduled TN radiation pattern relative to at least one of the corresponding one or more beams 108. Another type of beamforming performed by the beamforming engine 430 involves applying side lobe suppression to reduce gain in one or more side lobes of the pre-scheduled TN radiation pattern determined to be overlapping with at least one of the corresponding one or more beams. One or both of these types of beamforming can be performed by the beamforming engine 430 on any or all of the TN antenna radiation patterns to mitigate any of the interference conditions 425.

The beamforming engine 430 can generate beamforming signals 435 to direct beamforming of the radiation patterns. For example, the beamforming signals 435 can include phase and/or amplitude weighted data signals for communication by the TN antennas, weighting matrices, etc. In general, implementing the beamforming by the beamforming engine 430 involves manipulating the phase and/or amplitude of the signals transmitted from multiple antennas to create a focused radiation pattern, thereby effectively creating constructive interference (i.e., enhancing signal strength and quality) in specific directions while creating destructive interference in other directions.

The particulars of the beamforming depend on several factors, including the TN antenna array configuration. For example, each TN antenna can be implemented as an array of radiating elements that are in a certain configuration, including a certain number of elements, certain spacing between elements, etc. Different types of signal processing techniques can be used. For example, digital beamforming (DBF) is used to control the amplitude and phase of the signals before they are fed to the TN antennas, analog beamforming is used to adjust the phase of the signals directly at the TN antenna elements, or hybrid beamforming is used to combine digital and analog techniques. Different types of beamforming algorithms can also be used. For example, direction of arrival (DoA) algorithms can determine the direction of incoming signals, precoding matrices can be calculated to determine optimal phase and amplitude adjustments, predefined codebooks can be defined with sets of beamforming vectors corresponding to different directions, etc. Typically, several feedback mechanisms can also be included to ensure that the TN antennas and their radiating elements remain calibrated (e.g., to account for physical imperfections, environmental factors, etc.).

As one illustrative example, to focus a beam at 30 degrees from the boresight, phase shifts can be calculated using the formula: Δφ=(2πd/λ)sin(θ), where Δφ is the phase shift, d is the distance between antenna elements, λ is the wavelength, and θ is the desired angle. The calculated phase shifts can then be applied to the signal at each antenna element. Further, amplitudes can be adjusted (e.g., using tapering) to control side lobes. The signals can then be combined all antenna elements to form a desired radiation pattern.

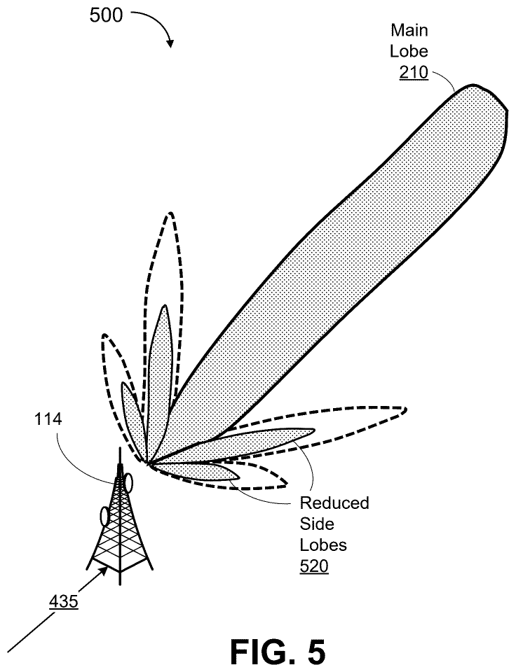

FIG. 5 shows a simplified terrestrial network (TN) portion of a communication environment 500 in which a terrestrial network (TN) antenna radiation pattern is beamformed using side lobe suppression. As shown, a cell tower 114 is producing a radiation pattern having a main lobe 210 and side lobes. The original (i.e., pre-scheduled, un-beamformed) side lobes are shown as dashed lines for reference. The side lobe suppression results in reduced (i.e., suppressed) side lobes 520. The side lobe suppression is applied based on the beamforming signals 435. Simplistically, the beamforming signals 435 are shown as provided directly to the cell tower 114. In practice, the beamforming signals 435 are provided to any suitable network location(s) for performing the beamforming, as described above.

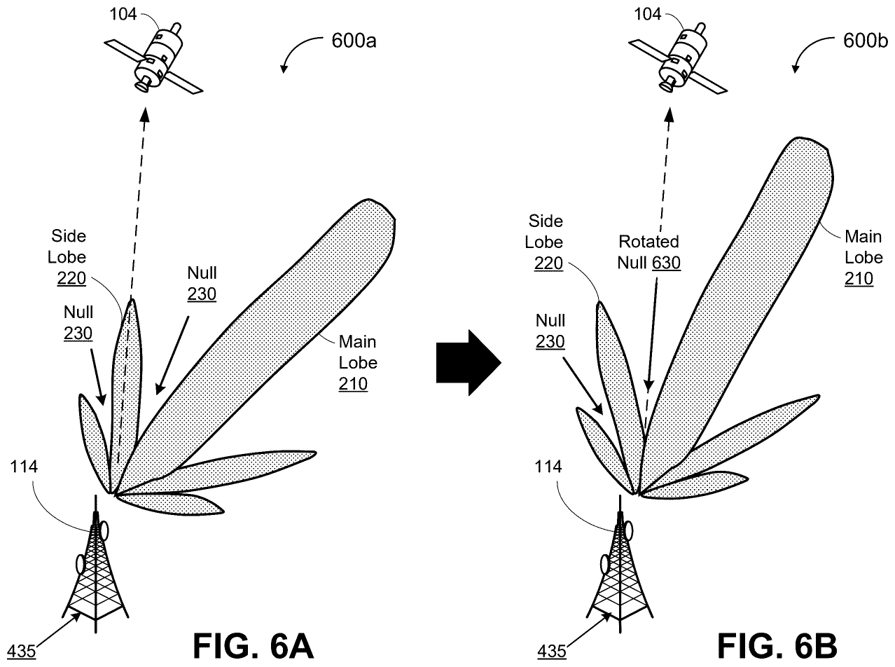

FIGS. 6A and 6B show a simplified terrestrial network (TN) portion of a communication environment 600 in which a terrestrial network (TN) antenna radiation pattern is beamformed using beam rotation. As shown, a cell tower 114 is producing a radiation pattern having a main lobe 210, side lobes 220, and nulls 230. FIG. 6A shows the pre-scheduled (i.e., un-beamformed) radiation pattern. FIG. 6A further shows that one of the side lobes 220 of the pre-scheduled radiation pattern is pointing directly at, and is presumably interfering with communications of, a satellite 104. FIG. 6B shows the beamformed radiation pattern, in which all the lobes and nulls 230 are rotated. In particular, FIG. 6B shows that the previously interfering side lobe 220 is no longer pointing in the direction of the satellite 104. Instead, a rotated null 630 is now pointing at the satellite 104, such that there is near-zero gain from the terrestrial antenna in the direction of the satellite 104.

The beam rotation is applied based on the beamforming signals 435. Simplistically, the beamforming signals 435 are shown as provided directly to the cell tower 114. In practice, the beamforming signals 435 are provided to any suitable network location(s) for performing the beamforming, as described above. As described above, the beam rotation is ideally performed so that a null is 230 is pointing directly in the direction of a potentially interfering satellite 104. In practice, however, the granularity of an angle shift direction (i.e., the amount and/or precision of beam rotation) depends on the antenna characteristics, such as the number of antenna elements and the distance between them. As such, reference herein to pointing a null 230, or otherwise to beam rotation, intends to include any attempt to reduce or minimize TN DL interference on an NTN UL on the satellite 104 payload, even though the rotation is practically limited (i.e., the rotation may not be able to precisely point a null 230 directly toward a potentially interfering satellite 104).

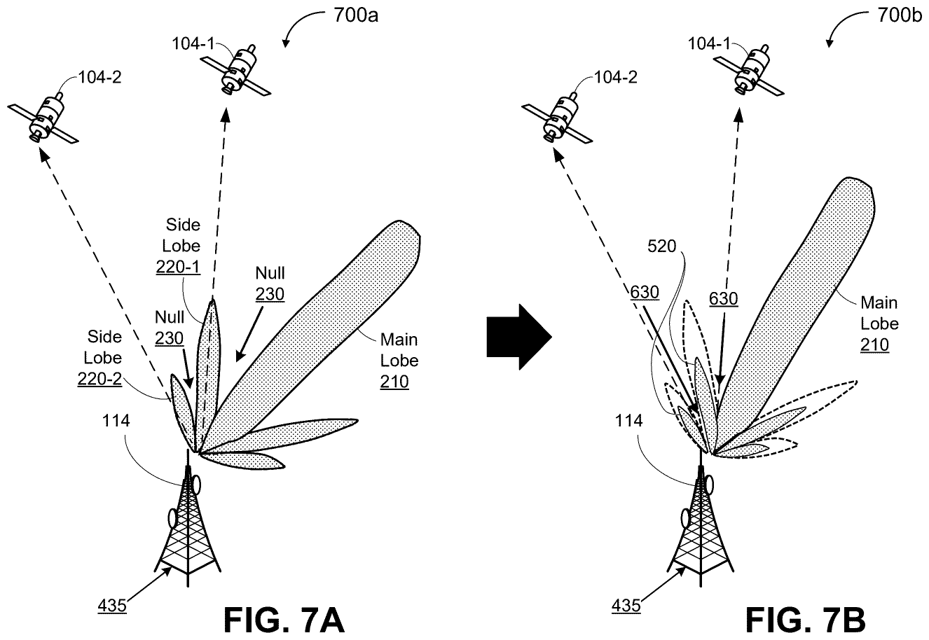

FIGS. 7A and 7B show a simplified terrestrial network (TN) portion of a communication environment 700 in which a terrestrial network (TN) antenna radiation pattern is beamformed using both side lobe suppression and beam rotation. As shown, a cell tower 114 is producing a radiation pattern having a main lobe 210, side lobes 220, and nulls 230. FIG. 7A shows the pre-scheduled (i.e., un-beamformed) radiation pattern. FIG. 7A further shows that a first of the side lobes 220-1 of the pre-scheduled radiation pattern is pointing directly at, and is presumably interfering with communications of, a first satellite 104-1; and a second of the side lobes 220-2 of the pre-scheduled radiation pattern is pointing directly at, and is presumably interfering with communications of, a second satellite 104-2.

FIG. 7B shows the beamformed radiation pattern, in which all the lobes and nulls 230 are rotated and the side lobes 220 are suppressed. In particular, FIG. 7B shows that the previously interfering first side lobe 220-1 is no longer pointing in the direction of the first satellite 104-1; instead, a rotated null 630 is now pointing at the first satellite 104-1, such that there is near-zero gain from the terrestrial antenna in the direction of the first satellite 104-1. With regard to the second satellite 104-2, the beam rotation is insufficient by itself to avoid interference with the second side lobe 220-2. However, also suppressing the side lobe (suppressed side lobes 520) effectively removes the portion of the side lobe 220-2 that would still be interfering with the satellite 104-2, such that the second satellite 104-2 is effectively aligned with a rotated null 630, as shown.

As in FIGS. 5 and 6, the beamforming (both the beam rotation and the side lobe suppression) is applied based on the beamforming signals 435. Simplistically, the beamforming signals 435 are shown as provided directly to the cell tower 114. In practice, the beamforming signals 435 are provided to any suitable network location(s) for performing the beamforming, as described above.

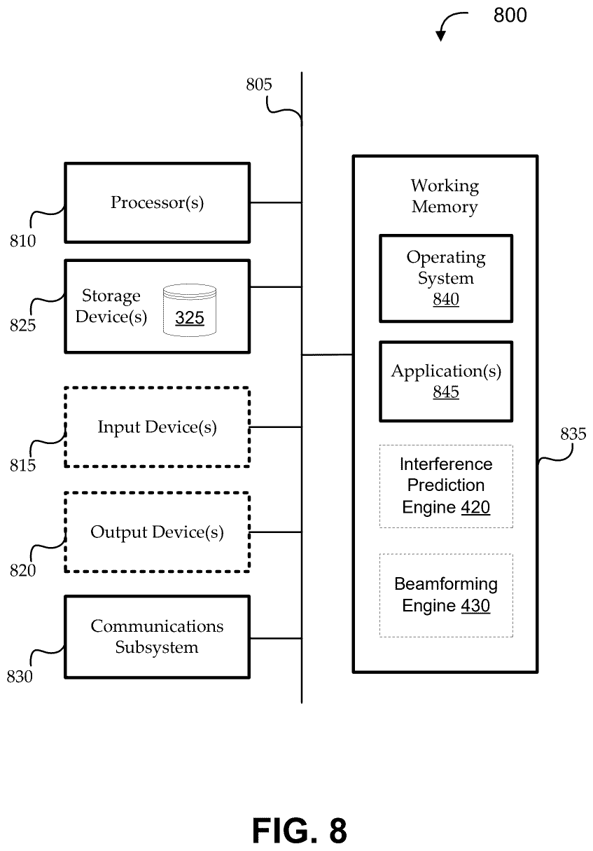

In some embodiments, components of the NTN-aware TN beamformer 410 can be implemented in a computational environment. FIG. 8 provides a schematic illustration of an embodiment of a computational system 800 that can implement various system components and/or perform various steps of methods provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computational system 800 is shown including hardware elements that can be electrically coupled via a bus 805 (or may otherwise be in communication, as appropriate). The hardware elements may include one or more processors 810, including, without limitation, one or more general-purpose processors and/or one or more special-purpose processors (such as digital signal processing chips, graphics acceleration processors, video decoders, and/or the like). Optionally, embodiments of the computational system 800 can include one or more input devices 815, and/or one or more output devices 820. The input devices 815 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 820 can include user output devices (e.g., display devices, printers, and/or the like), and/or machine input devices (e.g., computer-to-computer interfaces, such as wired and/or wireless output data ports).

The computational system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 825 include memory for storing ephemeris data 412, beam data 414, cell data 416, interference conditions 425, and/or other information used by embodiments to implement features described herein. For example, the storage devices 825 can include database(s) 325.

The computational system 800 can also include a communications subsystem 830, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. Depending on where in the network the computational system 800 is deployed, the communications subsystem 830 can include any suitable hardware and/or software components for communicating with other salient portions of the network.

The computational system 800 further includes a working memory 835, which can include a RAM or ROM device, as described herein. The computational system 800 also can include software elements, shown as currently being located within the working memory 835, including an operating system 840, device drivers, executable libraries, and/or other code, such as one or more application programs 845, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 840 and the working memory 835 can be used in conjunction with the one or more processors 810 to implement the some or all of the interference prediction engine 420 and/or the beamforming engine 430.

A set of these instructions and/or codes can be stored on a non-transitory (or non-transient) computer-readable storage medium, such as the non-transitory storage device(s) 825 described above. In some cases, the storage medium can be incorporated within a computer system, such as computational system 800. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 800 and/or can take the form of source and/or installable code, which, upon compilation and/or installation on the computational system 800 (e.g., using any of a variety of generally available compilers, installation programs, compression/decompression utilities, etc.), then takes the form of executable code.

In some embodiments, the computational system 800 implements a portion of a system for communicating a data signal in a wireless communication network, as described herein. The non-transitory storage device(s) 825 can have instructions stored thereon, which, when executed, cause the processor(s) 810 to perform steps, including: determining a plurality of interference conditions by, for each cell of a plurality of cells of the TN, for each schedule time of a plurality of schedule times: determining, based on the cell data, a pre-scheduled TN radiation pattern for the cell in the schedule time; determining, based on the ephemeris data and the beam data, beam coverage areas of a plurality of beams produced by the NTN in the schedule time; and determining a set of interference conditions for the cell in the schedule time, such that each interference condition corresponds to an instance in which the pre-scheduled TN radiation pattern is overlapped by one or more of the beam coverage areas of one or more of the beams, thereby producing corresponding co-channel interference between the cell as an corresponding cell and the one or more of the beams as corresponding one or more beams during the schedule time as an corresponding schedule time; and directing beamforming, for each of the plurality of interference conditions, of the pre-scheduled TN radiation pattern for the corresponding cell in the corresponding schedule time to mitigate the corresponding co-channel interference with the corresponding one or more beams.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 800) to perform methods in accordance with various embodiments of the invention. According to a set of embodiments, some or all of the procedures of such methods are performed by the computational system 800 in response to processor 810 executing one or more sequences of one or more instructions (which can be incorporated into the operating system 840 and/or other code, such as an application program 845) contained in the working memory 835. Such instructions may be read into the working memory 835 from another computer-readable medium, such as one or more of the non-transitory storage device(s) 825. Merely by way of example, execution of the sequences of instructions contained in the working memory 835 can cause the processor(s) 810 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 800, various computer-readable media can be involved in providing instructions/code to processor(s) 810 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 825. Volatile media include, without limitation, dynamic memory, such as the working memory 835. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a disk of a remote computer. The remote computer can load the instructions into its dynamic memory and send the instructions as signals over a transmission medium to be received and/or executed by the computational system 800. The communications subsystem 830 (and/or components thereof) generally will receive signals, and the bus 805 then can carry the signals (and/or the data, instructions, etc., carried by the signals) to the working memory 835, from which the processor(s) 810 retrieves and executes the instructions. The instructions received by the working memory 835 may optionally be stored on a non-transitory storage device 825 either before or after execution by the processor(s) 810.

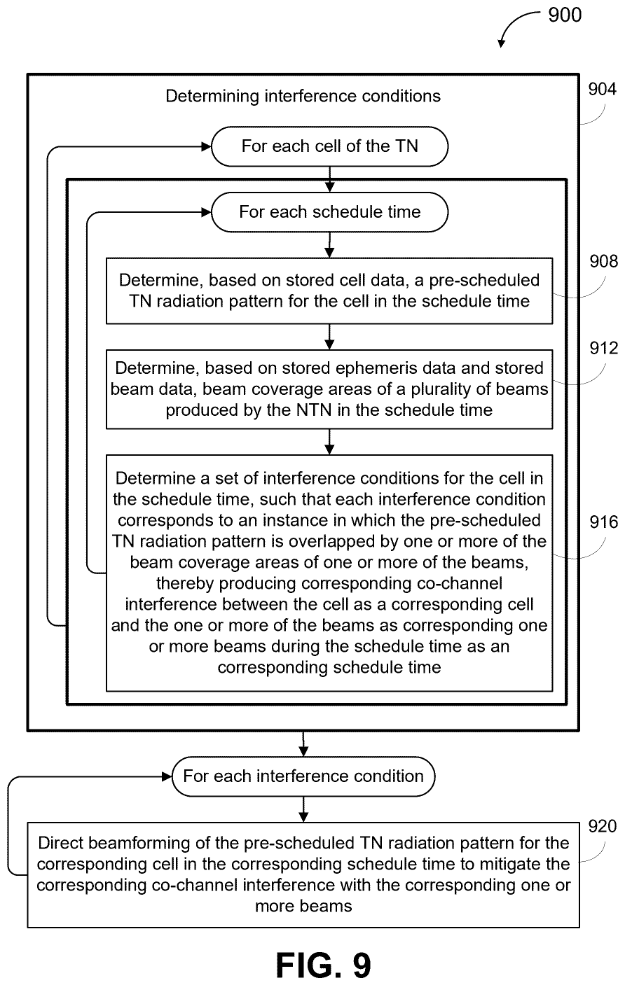

FIG. 9 shows a flow diagram of an illustrative method 900 for non-terrestrial network (NTN) aware terrestrial network (TN) co-channel interference mitigation, according to embodiments described herein. Embodiments of the method 900 begin at stage 904 by determining interference conditions. As illustrated, this determination can be iteratively performing stages 908-916 for each of multiple cells of the TN, for each of multiple schedule times.

At stage 908, embodiments can determine, based on stored cell data, a pre-scheduled TN radiation pattern for the cell in the schedule time.

At stage 912, embodiments can determine, based on stored ephemeris data and stored beam data, beam coverage areas of a plurality of beams produced by the NTN in the schedule time.

At stage 916, embodiments can determine a set of interference conditions for the cell in the schedule time. The determination at stage 916 is such that each interference condition corresponds to an instance in which the pre-scheduled TN radiation pattern is overlapped by one or more of the beam coverage areas of one or more of the beams. As described herein, such an overlap (i.e., in time, space, and frequency) produces corresponding co-channel interference between the cell (i.e., the radiation pattern of a particular TN antenna) as a corresponding cell and the one or more of the beams as corresponding one or more beams during the schedule time as an corresponding schedule time. As described herein, embodiments generally assume that each interference condition is either an instance in which downlink TN transmission via the corresponding cell produces the corresponding co-channel interference with uplink NTN reception via the corresponding one or more beams, or is an instance in which downlink NTN transmission via the corresponding one or more beams produces the corresponding co-channel interference with uplink TN reception via the corresponding cell.

After iterating through stages 908-916 for each of multiple cells of the TN and for each of multiple schedule times, embodiments can continue to iterate stage 920 for each of the determined interference conditions. At stage 920, for each interference condition, embodiments can direct beamforming of the pre-scheduled TN radiation pattern for the corresponding cell in the corresponding schedule time to mitigate the corresponding co-channel interference with the corresponding one or more beams. Computations can seek a beamforming solution that maximizes the quality of the NTN channel with minimum impact to the gain of the TN channels.

In some cases, the directing beamforming at stage 920 includes computing a transformation which, when applied to the pre-scheduled TN radiation pattern for the corresponding cell in the corresponding schedule time, mitigates the corresponding co-channel interference with the corresponding one or more beams by applying a rotation to the pre-scheduled TN radiation pattern to align at least one of the one or more nulls of the pre-scheduled TN radiation pattern relative to at least one of the corresponding one or more beams and/or by applying a side lobe suppression to reduce gain in at least one of the one or more side lobes of the pre-scheduled TN radiation pattern determined to be overlapping with at least one of the corresponding one or more beams. In such cases, the directing at stage 920 further includes directing the beamforming to apply the computed transformation to the pre-scheduled TN radiation pattern for the corresponding cell in the corresponding schedule time.

In some cases, the directing beamforming at stage 920 includes computing a pointing rotation which, when applied to the pre-scheduled TN radiation pattern for the corresponding cell in the corresponding schedule time, mitigates the corresponding co-channel interference with the corresponding one or more beams by aligning at least one of the one or more nulls of the pre-scheduled TN radiation pattern relative to at least one of the corresponding one or more beams. In such cases, the directing at stage 920 further includes directing the beamforming to apply the computed pointing rotation to the pre-scheduled TN radiation pattern for the corresponding cell in the corresponding schedule time. In some such cases, computing the pointing rotation is performed by computing multiple candidate pointing rotations which, when applied to the pre-scheduled TN radiation pattern for the corresponding cell in the corresponding schedule time, mitigates the corresponding co-channel interference with the corresponding one or more beams by aligning at least one of the one or more nulls of the pre-scheduled TN radiation pattern relative to at least one of the corresponding one or more beams; computing a corresponding magnitude of TN gain reduction caused to the corresponding cell by applying the candidate pointing rotation; and directing the beamforming to apply one of the plurality of candidate pointing rotations to the pre-scheduled TN radiation pattern for the corresponding cell in the corresponding schedule time based on determining which of the plurality of candidate pointing rotations causes a lowest corresponding magnitude of TN gain reduction to the corresponding cell.

In some cases, the directing beamforming at stage 920 includes computing a side lobe suppression which, when applied to the pre-scheduled TN radiation pattern for the corresponding cell in the corresponding schedule time, mitigates the corresponding co-channel interference with the corresponding one or more beams by reducing gain in at least one of the one or more side lobes of the pre-scheduled TN radiation pattern determined to be overlapping with at least one of the corresponding one or more beams. In such cases, the directing at stage 920 further includes directing the beamforming to apply the computed side lobe suppression to the pre-scheduled TN radiation pattern for the corresponding cell in the corresponding schedule time. In some such cases, computing the side lobe suppression is performed by computing a plurality of candidate side lobe suppressions which, when applied to the pre-scheduled TN radiation pattern for the corresponding cell in the corresponding schedule time, mitigates the corresponding co-channel interference with the corresponding one or more beams by reducing gain in at least one of the one or more side lobes of the pre-scheduled TN radiation pattern determined to be overlapping with at least one of the corresponding one or more beams; computing a corresponding magnitude of TN gain reduction caused to the corresponding cell by applying the candidate side lobe suppression; and directing the beamforming to apply one of the plurality of candidate side lobe suppressions to the pre-scheduled TN radiation pattern for the corresponding cell in the corresponding schedule time based on determining which of the plurality of candidate side lobe suppressions causes a lowest corresponding magnitude of TN gain reduction to the corresponding cell.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for non-terrestrial network (NTN) aware terrestrial network (TN) co-channel interference mitigation, the method comprising:
determining a plurality of interference conditions by, for each cell of a plurality of cells of the TN, for each schedule time of a plurality of schedule times:
determining, based on stored cell data, a pre-scheduled TN radiation pattern for the cell in the schedule time;
determining, based on stored ephemeris data and stored beam data, beam coverage areas of a plurality of beams produced by the NTN in the schedule time; and
determining a set of interference conditions for the cell in the schedule time, such that each interference condition corresponds to an instance in which the pre-scheduled TN radiation pattern is overlapped by one or more of the beam coverage areas of one or more of the beams, thereby producing corresponding co-channel interference between the cell as a corresponding cell and the one or more of the beams as corresponding one or more beams during the schedule time as an corresponding schedule time; and
directing beamforming, for each of the plurality of interference conditions, of the pre-scheduled TN radiation pattern for the corresponding cell in the corresponding schedule time to mitigate the corresponding co-channel interference with the corresponding one or more beams.

2. The method of claim 1, wherein each interference condition corresponds to one of:
an instance in which downlink TN transmission via the corresponding cell produces the corresponding co-channel interference with uplink NTN reception via the corresponding one or more beams; or
an instance in which downlink NTN transmission via the corresponding one or more beams produces the corresponding co-channel interference with uplink TN reception via the corresponding cell.

3. The method of claim 1, wherein the pre-scheduled TN radiation pattern for each cell in each schedule time comprises:
a plurality of lobes including a main lobe pointing in a main lobe direction, and one or more side lobes each pointing in a corresponding side lobe direction angularly offset from the main lobe direction; and
one or more nulls between each adjacent lobe of the plurality of lobes.

4. The method of claim 3, wherein the directing beamforming, for each of the plurality of interference conditions, comprises:
computing a transformation which, when applied to the pre-scheduled TN radiation pattern for the corresponding cell in the corresponding schedule time, mitigates the corresponding co-channel interference with the corresponding one or more beams by applying a rotation to the pre-scheduled TN radiation pattern to align at least one of the one or more nulls of the pre-scheduled TN radiation pattern relative to at least one of the corresponding one or more beams and/or by applying a side lobe suppression to reduce gain in at least one of the one or more side lobes of the pre-scheduled TN radiation pattern determined to be overlapping with at least one of the corresponding one or more beams; and
directing the beamforming to apply the computed transformation to the pre-scheduled TN radiation pattern for the corresponding cell in the corresponding schedule time.

5. The method of claim 3, wherein the directing beamforming, for each of at least one of the plurality of interference conditions, comprises:
computing a pointing rotation which, when applied to the pre-scheduled TN radiation pattern for the corresponding cell in the corresponding schedule time, mitigates the corresponding co-channel interference with the corresponding one or more beams by aligning at least one of the one or more nulls of the pre-scheduled TN radiation pattern relative to at least one of the corresponding one or more beams; and
directing the beamforming to apply the computed pointing rotation to the pre-scheduled TN radiation pattern for the corresponding cell in the corresponding schedule time.

6. The method of claim 3, wherein the directing beamforming, for each of at least one of the plurality of interference conditions, comprises:
computing a plurality of candidate pointing rotations which, when applied to the pre-scheduled TN radiation pattern for the corresponding cell in the corresponding schedule time, mitigates the corresponding co-channel interference with the corresponding one or more beams by aligning at least one of the one or more nulls of the pre-scheduled TN radiation pattern relative to at least one of the corresponding one or more beams;
computing, for each of the plurality of candidate pointing rotations, a corresponding magnitude of TN gain reduction caused to the corresponding cell by applying the candidate pointing rotation; and
directing the beamforming to apply one of the plurality of candidate pointing rotations to the pre-scheduled TN radiation pattern for the corresponding cell in the corresponding schedule time based on determining which of the plurality of candidate pointing rotations causes a lowest corresponding magnitude of TN gain reduction to the corresponding cell.

7. The method of claim 3, wherein the directing beamforming, for each of at least one of the plurality of interference conditions, comprises:
computing a side lobe suppression which, when applied to the pre-scheduled TN radiation pattern for the corresponding cell in the corresponding schedule time, mitigates the corresponding co-channel interference with the corresponding one or more beams by reducing gain in at least one of the one or more side lobes of the pre-scheduled TN radiation pattern determined to be overlapping with at least one of the corresponding one or more beams; and
directing the beamforming to apply the computed side lobe suppression to the pre-scheduled TN radiation pattern for the corresponding cell in the corresponding schedule time.

8. The method of claim 3, wherein the directing beamforming, for each of at least one of the plurality of interference conditions, comprises:
computing a plurality of candidate side lobe suppressions which, when applied to the pre-scheduled TN radiation pattern for the corresponding cell in the corresponding schedule time, mitigates the corresponding co-channel interference with the corresponding one or more beams by reducing gain in at least one of the one or more side lobes of the pre-scheduled TN radiation pattern determined to be overlapping with at least one of the corresponding one or more beams;
computing, for each of the plurality of candidate side lobe suppressions, a corresponding magnitude of TN gain reduction caused to the corresponding cell by applying the candidate side lobe suppression; and
directing the beamforming to apply one of the plurality of candidate side lobe suppressions to the pre-scheduled TN radiation pattern for the corresponding cell in the corresponding schedule time based on determining which of the plurality of candidate side lobe suppressions causes a lowest corresponding magnitude of TN gain reduction to the corresponding cell.

9. A system for non-terrestrial network (NTN) aware terrestrial network (TN) co-channel interference mitigation, the system comprising:
one or more processors; and
a non-transitory, computer-readable medium having, stored thereon:
cell data for the TN, ephemeris data for the NTN, and beam data for the NTN; and
instructions which, when executed, cause the one or more processors to perform steps comprising:
determining a plurality of interference conditions by, for each cell of a plurality of cells of the TN, for each schedule time of a plurality of schedule times:
determining, based on the cell data, a pre-scheduled TN radiation pattern for the cell in the schedule time;
determining, based on the ephemeris data and the beam data, beam coverage areas of a plurality of beams produced by the NTN in the schedule time; and
determining a set of interference conditions for the cell in the schedule time, such that each interference condition corresponds to an instance in which the pre-scheduled TN radiation pattern is overlapped by one or more of the beam coverage areas of one or more of the beams, thereby producing corresponding co-channel interference between the cell as an corresponding cell and the one or more of the beams as corresponding one or more beams during the schedule time as an corresponding schedule time; and
directing beamforming, for each of the plurality of interference conditions, of the pre-scheduled TN radiation pattern for the corresponding cell in the corresponding schedule time to mitigate the corresponding co-channel interference with the corresponding one or more beams.

10. The system of claim 9, wherein each interference condition corresponds to one of:
an instance in which downlink TN transmission via the corresponding cell produces the corresponding co-channel interference with uplink NTN reception via the corresponding one or more beams; or
an instance in which downlink NTN transmission via the corresponding one or more beams produces the corresponding co-channel interference with uplink TN reception via the corresponding cell.

11. The system of claim 9, wherein the pre-scheduled TN radiation pattern for each cell in each schedule time comprises:
a plurality of lobes including a main lobe pointing in a main lobe direction, and one or more side lobes each pointing in a corresponding side lobe direction angularly offset from the main lobe direction; and
one or more nulls between each adjacent lobe of the plurality of lobes.

12. The system of claim 11, wherein the directing beamforming, for each of the plurality of interference conditions, comprises:
computing a transformation which, when applied to the pre-scheduled TN radiation pattern for the corresponding cell in the corresponding schedule time, mitigates the corresponding co-channel interference with the corresponding one or more beams by applying a rotation to the pre-scheduled TN radiation pattern to align at least one of the one or more nulls of the pre-scheduled TN radiation pattern relative to at least one of the corresponding one or more beams and/or by applying a side lobe suppression to reduce gain in at least one of the one or more side lobes of the pre-scheduled TN radiation pattern determined to be overlapping with at least one of the corresponding one or more beams; and
directing the beamforming to apply the computed transformation to the pre-scheduled TN radiation pattern for the corresponding cell in the corresponding schedule time.

13. The system of claim 11, wherein the directing beamforming, for each of at least one of the plurality of interference conditions, comprises:
computing a pointing rotation which, when applied to the pre-scheduled TN radiation pattern for the corresponding cell in the corresponding schedule time, mitigates the corresponding co-channel interference with the corresponding one or more beams by aligning at least one of the one or more nulls of the pre-scheduled TN radiation pattern relative to at least one of the corresponding one or more beams; and
directing the beamforming to apply the computed pointing rotation to the pre-scheduled TN radiation pattern for the corresponding cell in the corresponding schedule time.

14. The system of claim 11, wherein the directing beamforming, for each of at least one of the plurality of interference conditions, comprises:
computing a plurality of candidate pointing rotations which, when applied to the pre-scheduled TN radiation pattern for the corresponding cell in the corresponding schedule time, mitigates the corresponding co-channel interference with the corresponding one or more beams by aligning at least one of the one or more nulls of the pre-scheduled TN radiation pattern relative to at least one of the corresponding one or more beams;
computing, for each of the plurality of candidate pointing rotations, a corresponding magnitude of TN gain reduction caused to the corresponding cell by applying the candidate pointing rotation; and
directing the beamforming to apply one of the plurality of candidate pointing rotations to the pre-scheduled TN radiation pattern for the corresponding cell in the corresponding schedule time based on determining which of the plurality of candidate pointing rotations causes a lowest corresponding magnitude of TN gain reduction to the corresponding cell.

15. The system of claim 11, wherein the directing beamforming, for each of at least one of the plurality of interference conditions, comprises:
computing a side lobe suppression which, when applied to the pre-scheduled TN radiation pattern for the corresponding cell in the corresponding schedule time, mitigates the corresponding co-channel interference with the corresponding one or more beams by reducing gain in at least one of the one or more side lobes of the pre-scheduled TN radiation pattern determined to be overlapping with at least one of the corresponding one or more beams; and
directing the beamforming to apply the computed side lobe suppression to the pre-scheduled TN radiation pattern for the corresponding cell in the corresponding schedule time.

16. The system of claim 11, wherein the directing beamforming, for each of at least one of the plurality of interference conditions, comprises:
computing a plurality of candidate side lobe suppressions which, when applied to the pre-scheduled TN radiation pattern for the corresponding cell in the corresponding schedule time, mitigates the corresponding co-channel interference with the corresponding one or more beams by reducing gain in at least one of the one or more side lobes of the pre-scheduled TN radiation pattern determined to be overlapping with at least one of the corresponding one or more beams;
computing, for each of the plurality of candidate side lobe suppressions, a corresponding magnitude of TN gain reduction caused to the corresponding cell by applying the candidate side lobe suppression; and
directing the beamforming to apply one of the plurality of candidate side lobe suppressions to the pre-scheduled TN radiation pattern for the corresponding cell in the corresponding schedule time based on determining which of the plurality of candidate side lobe suppressions causes a lowest corresponding magnitude of TN gain reduction to the corresponding cell.

17. A communication network system operating in a terrestrial network (TN) in coordination with a non-terrestrial network (NTN), the communication network system comprising:
an NTN-aware TN beamforming subsystem comprising:
a data store having, stored thereon, cell data for the TN, ephemeris data for the NTN, and beam data for the NTN;
an interference prediction engine configured to determine a plurality of interference conditions by, for each cell of a plurality of cells of the TN, for each schedule time of a plurality of schedule times:
determining, based on stored cell data, a pre-scheduled TN radiation pattern for the cell in the schedule time;
determining, based on stored ephemeris data and stored beam data, beam coverage areas of a plurality of beams produced by the NTN in the schedule time; and
determining a set of interference conditions for the cell in the schedule time, such that each interference condition corresponds to an instance in which the pre-scheduled TN radiation pattern is overlapped by one or more of the beam coverage areas of one or more of the beams, thereby producing corresponding co-channel interference between the cell as an corresponding cell and the one or more of the beams as corresponding one or more beams during the schedule time as an corresponding schedule time; and
a beamforming engine coupled with the interference prediction engine and configured to direct beamforming, for each of the plurality of interference conditions, of the pre-scheduled TN radiation pattern for the corresponding cell in the corresponding schedule time to mitigate the corresponding co-channel interference with the corresponding one or more beams.

18. The communication network system of claim 17, further comprising:
a radio access network (RAN) intelligence controller (RIC) having at least the interference prediction engine integrated therewith.

19. The communication network system of claim 17, wherein each interference condition corresponds to one of:
an instance in which downlink TN transmission via the corresponding cell produces the corresponding co-channel interference with uplink NTN reception via the corresponding one or more beams; or
an instance in which downlink NTN transmission via the corresponding one or more beams produces the corresponding co-channel interference with uplink TN reception via the corresponding cell.

20. The communication network system of claim 17, wherein the beamforming engine is configured to direct beamforming, for each of the plurality of interference conditions, by:
computing a transformation which, when applied to the pre-scheduled TN radiation pattern for the corresponding cell in the corresponding schedule time, mitigates the corresponding co-channel interference with the corresponding one or more beams by applying a rotation to the pre-scheduled TN radiation pattern to align one or more nulls of the pre-scheduled TN radiation pattern relative to at least one of the corresponding one or more beams and/or by applying side lobe suppression to reduce gain in one or more side lobes of the pre-scheduled TN radiation pattern determined to be overlapping with at least one of the corresponding one or more beams; and
directing the beamforming to apply the computed transformation to the pre-scheduled TN radiation pattern for the corresponding cell in the corresponding schedule time.
